(19) United States
(12) Patent Application Publication
(10) Pub. No.: US 2008/0180560 A1
(43) Pub. Date: Jul. 31, 2008

(54) SOLID-STATE IMAGING DEVICE, DRIVE METHOD OF SOLID-STATE IMAGING DEVICE, AND IMAGING APPARATUS

(76) Inventor: Yutaka Sato, Kurokawa-gun (JP)

Correspondence Address: BIRCH STEWART KOLASCH & BIRCH, PO BOX 747, FALLS CHURCH, VA, 22040-0747, US

(21) Appl. No.: 12/015,319

(22) Filed: Jan. 16, 2008

(30) Foreign Application Priority Data
Jan. 17, 2007 (JP) P2007-007986

(51) Int. Cl. H04N 5/335

(52) U.S. Cl. 348/314; 348/E05.091

(57) ABSTRACT

A solid-state imaging device is provided and includes: a semiconductor substrate; a plurality of photoelectric conversion sections disposed in a row direction and a column direction orthogonal to the row direction in the semiconductor substrate; vertical charge transfer sections that transfers signal charges generated in the photoelectric conversion sections in the column direction, the vertical charge transfer sections including: a plurality of vertical charge transfer electrodes disposed in the column direction and between columns of the photoelectric conversion sections; and charge reading regions that read the signal charges generated in each of the photoelectric conversion section into the vertical charge transfer electrodes on both sides adjacent to the each of the photoelectric conversion section; and a horizontal charge transfer section that transfers the signal charges from the vertical charge transfer sections in the row direction.

### BACKGROUND OF THE INVENTION

1. Field of the Invention

This invention relates to a solid-state imaging device for transferring a signal charge read from a photoelectric conversion section to a horizontal charge transfer section by a vertical charge transfer section and outputting the signal charge, a drive method of the solid-state imaging device, and an imaging apparatus.

2. Description of Related Art

Generally, available as a CCD type image sensor is the configuration of a solid-state imaging device including a plurality of photoelectric conversion sections arranged on a semiconductor substrate, vertical charge transfer sections (also called VCCD) each for reading a signal charge generated in each photoelectric conversion section and transferring the signal charge in a vertical direction of an imaging plane, and a horizontal charge transfer section (also called HCCD) for transferring the signal charge transferred from the end part of the VCCD in a horizontal direction of the imaging plane and outputting the signal charge to an output section.

At present, putting the CCD type image sensor into a larger number of pixels advances and making smaller the pixel size per pixel advances accordingly. To simply make the pixel smaller, if an attempt is made not to make small each photoelectric conversion section of a photodiode, etc., as much as possible, instead it is necessary for the VCCD area to be reduced and it is inevitable to lessen the capacity of signal charges that can be transferred in the VCCD. As the transfer capacity of the signal charges lessens, it will become a factor of degradation of the sensitivity of the solid-state imaging device.

Hitherto, a drive method of an interlace mode of ensuring the capacity of the signal charges that can be transferred by thinning out signal charges read from photodiodes in a vertical direction and using also the area of the VCCDs corresponding to the photodiodes reading not signal charges has been used as with a solid-state imaging device shown in FIG. 6. In FIG. 6, the crosshatched portion indicates a portion where a signal charge accumulates and the blank portion indicates a portion where a signal charge does not accumulate. FIG. 7 is a timing chart of drive pulse voltage applied to each of vertical charge transfer electrodes V1 to V12 making up VCCD at the reading time according to the interlace mode in the solid-state imaging device shown in FIG. 6.

The reading mode of a solid-state imaging device in a related art also includes a progressive mode of reading a signal charge from each pixel into a VCCD at the same time and transferring the signal charge. Further, in addition to the configuration made up of the 12 vertical charge transfer electrodes V1 to V12 as shown in FIG. 6, the VCCD may be of a configuration of six vertical charge transfer electrodes V1 to V6 for thinning out with respect to the vertical direction of arranged photodiodes and reading according to the interlace mode, for example, as shown in FIG. 9. Further, another example of the interlace mode is disclosed in JP-A-2004-214363.

By the way, as making smaller the solid-state imaging device advances, the number of pixels thinned out at the reading time increases and the VCCD for accumulating the read signal charges lengthens in the vertical direction and thus it is necessary to increase the number of vertical charge transfer electrodes for driving the VCCD. That is, if it is assumed that the same signal charges are transferred, the solid-state imaging device made smaller would need to be provided with a larger number of vertical charge transfer electrodes than a solid-state imaging device not made smaller and it becomes necessary to increase the number of terminals provided in a solid-state imaging apparatus with the solid-state imaging device packaged and also the wiring of a drive circuit becomes complicated in response to an increase in the number of vertical charge transfer electrodes; these points are susceptible to improvement.

### SUMMARY OF THE INVENTION

An object of an illustrative, non-limiting embodiment of the invention is to provide a solid-state imaging device capable of ensuring capacity of signal charges transferred on a vertical charge transfer path if an imaging area is made smaller, a drive method of the solid-state imaging device, and an imaging apparatus.

According to an aspect of the invention, the object of the invention can be accomplished according to the following means:
(1) A solid-state imaging device comprising:

a semiconductor substrate;

a plurality of photoelectric conversion sections disposed in a row direction and a column direction orthogonal to the row direction in the semiconductor substrate;

vertical charge transfer sections that transfers signal charges generated in the photoelectric conversion sections in the column direction, wherein the vertical charge transfer sections includes: a plurality of vertical charge transfer electrodes disposed in the column direction and between columns of the photoelectric conversion sections; and charge reading regions that read the signal charges generated in each of the photoelectric conversion section into the vertical charge transfer electrodes on both sides adjacent to the each of the photoelectric conversion section; and

a horizontal charge transfer section that transfers the signal charges from the vertical charge transfer sections in the row direction.
(2) The solid-state imaging device according to the above (1), wherein the horizontal charge transfer section includes four or more horizontal charge transfer electrodes arranged in order in the row direction.
(3) The solid-state imaging device according to the above (1), further comprising a line memory that temporarily accumulates the signal charges transferred from the vertical charge transfer sections.
(4) A method for driving a solid-state imaging device including: a semiconductor substrate; a plurality of photoelectric conversion sections disposed in a row direction and a column direction orthogonal to the row direction in the semiconductor substrate; vertical charge transfer sections that transfers signal charges generated in the photoelectric conversion sections in the column direction, the vertical charge transfer sections including a plurality of vertical charge transfer electrodes disposed in the column direction and between columns of the photoelectric conversion sections; and a horizontal charge transfer section that transfers the signal charges from the vertical charge transfer sections in the row direction, the method comprising reading the signal charges generated in each of the photoelectric conversion section into the vertical charge transfer electrodes on both sides adjacent to the each of the photoelectric conversion section.
(5) The method according to the above (4), further comprising adding the signal charges read from the same photoelectric conversion section in the horizontal charge transfer section.
(6) The method according to the above (4), further comprising: outputting the signal charges from the horizontal charge transfer section; and adding the signal charges read from the same photoelectric conversion section in a signal processing section.
(7) An imaging apparatus comprising a solid-state imaging device that performs photoelectric conversion of light from a subject,

the solid-state imaging device including:

a semiconductor substrate;

a plurality of photoelectric conversion sections disposed in a row direction and a column direction orthogonal to the row direction in the semiconductor substrate;

vertical charge transfer sections that transfers signal charges generated in the photoelectric conversion sections in the column direction, wherein the vertical charge transfer sections includes: a plurality of vertical charge transfer electrodes disposed in the column direction and between columns of the photoelectric conversion sections; and charge reading regions that read the signal charges generated in each of the photoelectric conversion section into the vertical charge transfer electrodes on both sides adjacent to the each of the photoelectric conversion section; and

a horizontal charge transfer section that transfers the signal charges from the vertical charge transfer sections in the row direction.

### BRIEF DESCRIPTION OF THE DRAWINGS

The features of the invention will appear more fully upon consideration of the exemplary embodiments of the inventions, which are schematically set forth in the drawings, in which:

FIG. 1 is a functional block diagram of a digital camera for functioning as a solid-state imaging apparatus including a solid-state imaging device according to an exemplary embodiment of the invention;

FIG. 2 is a plan view of a solid-state imaging device according to a first exemplary embodiment of the invention;

FIG. 3 is a timing chart of drive pulse voltage applied to vertical charge transfer electrodes when the solid-state imaging device shown in FIG. 2 is driven;

FIG. 4 is a plan view of a solid-state imaging device according to a second exemplary embodiment of the invention;

FIG. 5 is a timing chart of drive pulse voltage applied to vertical charge transfer electrodes when the solid-state imaging device shown in FIG. 4 is driven;

FIG. 6 is a plan view to show the configuration of a solid-state imaging device in a related art;

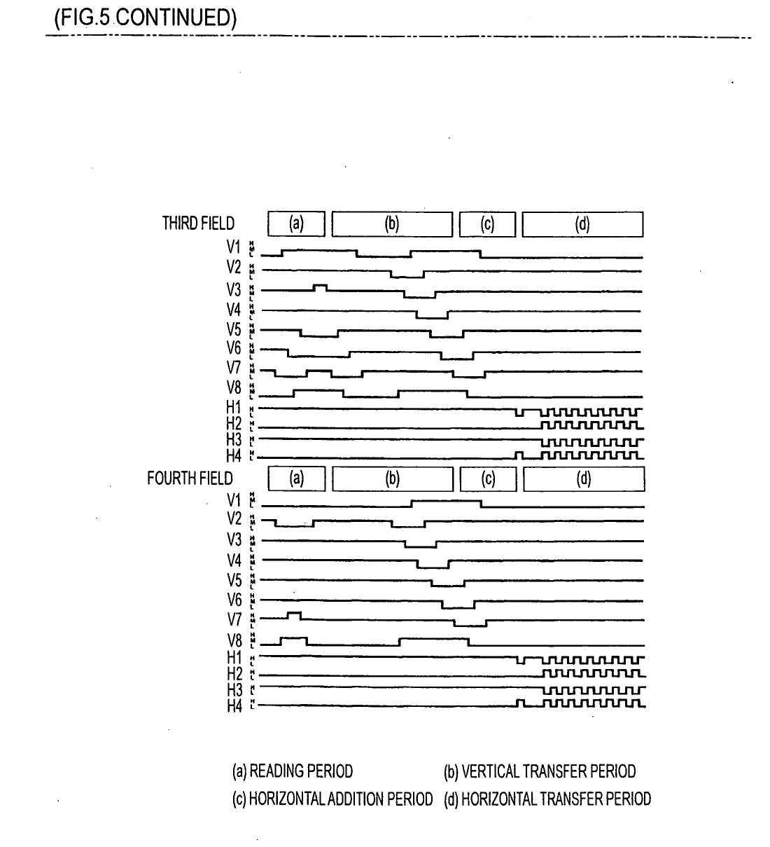

FIG. 7 is a timing chart of drive pulse voltage applied to each of vertical charge transfer electrodes making up VCCD at the reading time according to an interlace mode in the solid-state imaging device shown in FIG. 6;

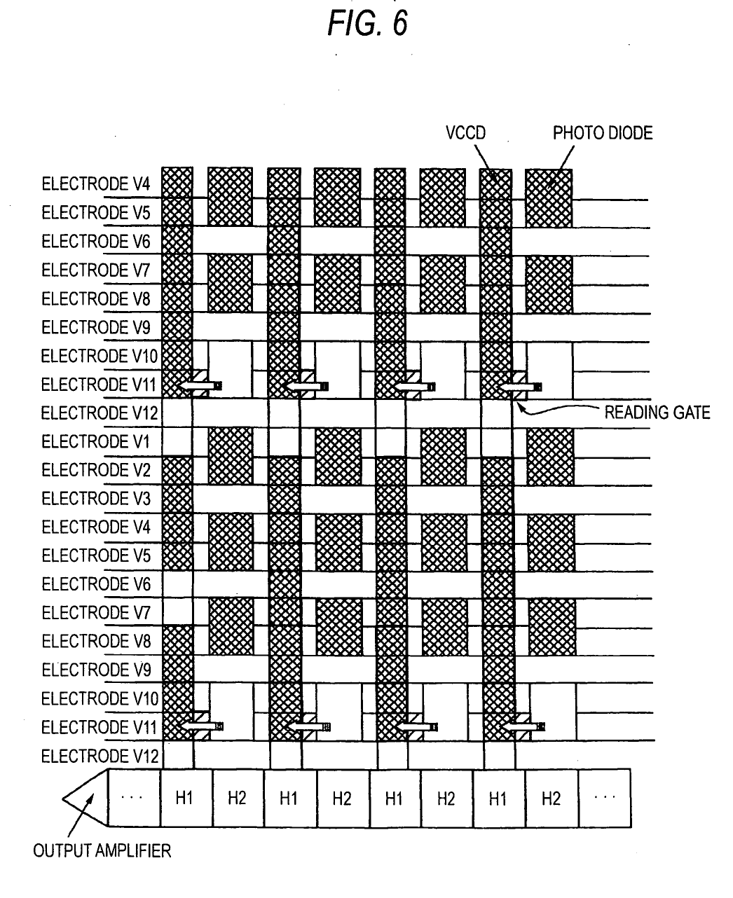

FIG. 8 is a drawing to show reading of a solid-state imaging device according to a progressive mode; and

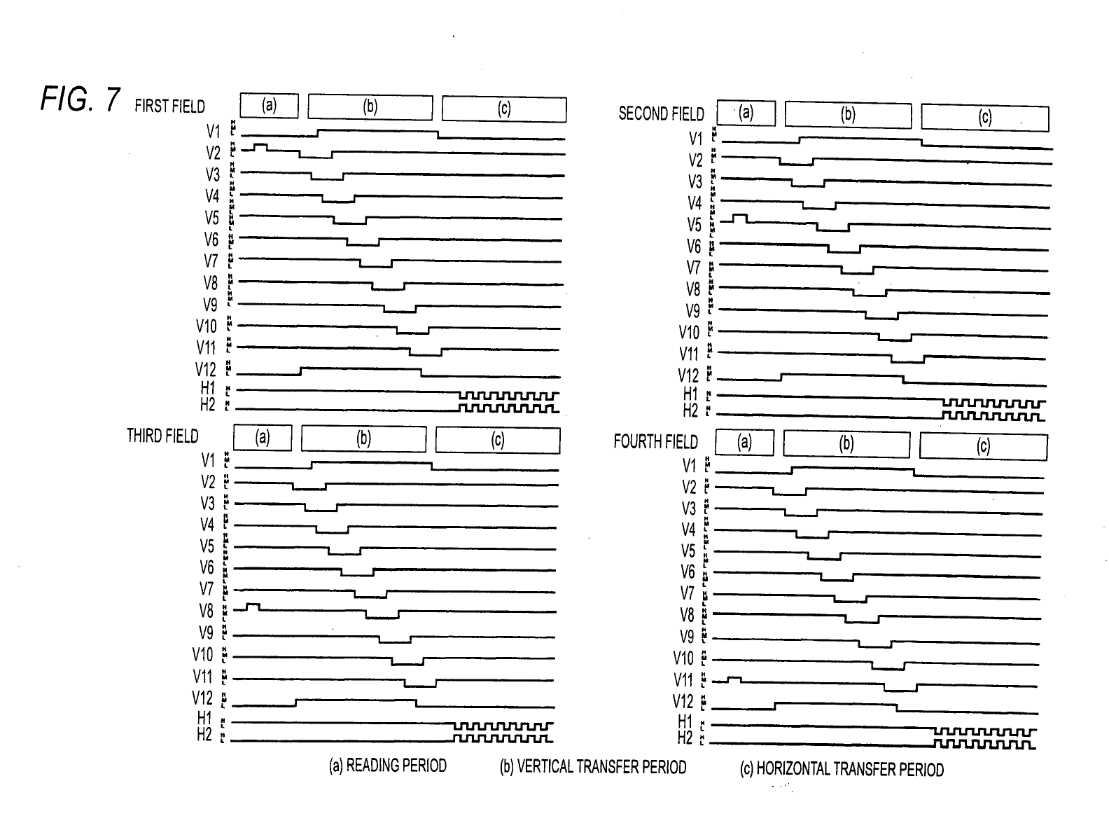

FIG. 9 is a drawing to show reading of a solid-state imaging device according to another interlace mode.

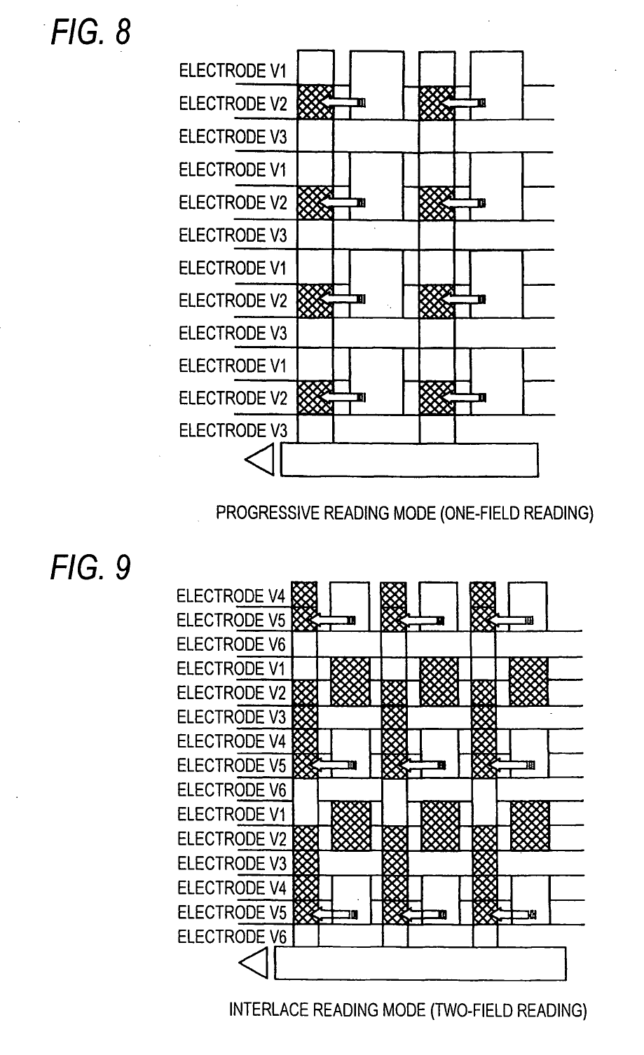

### DETAILED DESCRIPTION OF THE EXEMPLARY EMBODIMENTS

Although the invention will be described below with reference to the exemplary embodiment thereof, the following exemplary embodiment and its modification do not restrict the invention.

In an aspect of the invention, at the driving time, the signal charge accumulated in the photoelectric conversion section can be transferred to the vertical charge transfer sections disposed adjacent to both sides of the photoelectric conversion section at the same time. In the solid-state imaging device in the related art, the signal charge is read to the vertical charge transfer section only on one side relative to the photoelectric conversion section and thus to make smaller the solid-state imaging device, it is necessary to increase the number of vertical charge transfer electrodes making up the vertical charge transfer section with an increase in the number of photoelectric conversion sections to be thinned out. In contrast, in the solid-state imaging device of the invention, the signal charge is read to the vertical charge transfer sections on both sides of the photoelectric conversion section, whereby the signal charge can be accumulated in the vertical charge transfer electrodes making up each of the vertical charge transfer sections. Thus., the signal charges of a larger capacity as compared with the solid-state imaging device in the related art are accumulated and the signal charges can be transferred at the same time in the vertical direction in the vertical charge transfer sections. Since the signal charges of the same photoelectric conversion section can be added by the horizontal charge transfer section and the signal processing section, the capacity of the signal charges can be ensured without increasing the number of the vertical charge transfer electrodes in response to making smaller the solid-state imaging device.

According to an aspect of the invention, there can be provided the solid-state imaging device capable of ensuring capacity of signal charges transferred on a vertical charge transfer path if an imaging area is made smaller, the drive method of the solid-state imaging device, and the imaging apparatus.

Exemplary embodiments of the invention will be discussed below in detail based on the accompanying drawings:

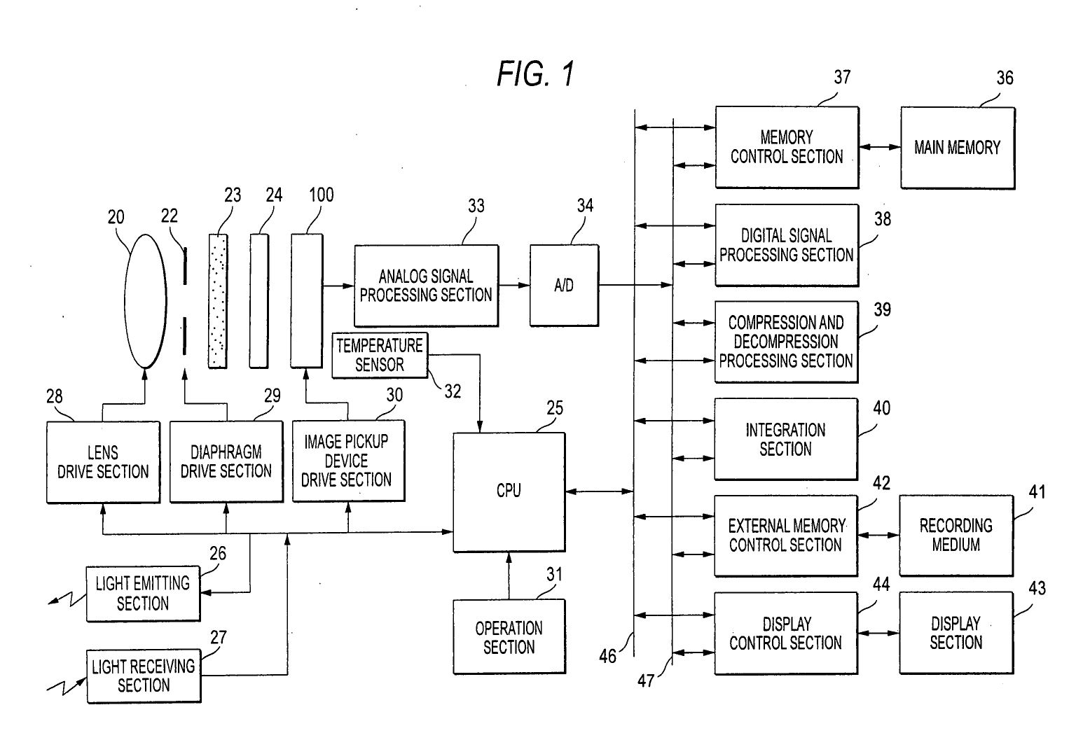

FIG. 1 is a functional block diagram of a digital camera of an example of an imaging apparatus including a solid-state imaging device of an exemplary embodiment of the invention. The digital camera shown in the figure includes a taking lens 20, a CCD type solid-state imaging device 100, and a diaphragm 22, an infrared cut filter 23, and an optical low-pass filter 24 provided between the taking lens 20 and the solid-state imaging device 100.

A CPU 25 for controlling the whole of an electric control system of the digital camera controls a flash light emitting section 26 and a light receiving section 27, controls a lens drive section 28 to adjust the position of the taking lens 20 to a focus position and make zoom adjustment, and controls the aperture amount of the diaphragm through a diaphragm drive section 29 to make light exposure adjustment.

The CPU 25 also drives the solid-state imaging device 100 through an imaging device drive section 30 and outputs light from a subject picked up through the taking lens 20 as a color signal. A command signal from the user is input to the CPU 25 through an operation section 31. A detection signal from a temperature sensor 32 for detecting the temperature of the solid-state imaging device 100 is also input to the CPU 25. The CPU 25 performs various types of control in accordance with the signals.

The electric control system of the digital camera further includes an analog signal processing section 33 connected to output of the solid-state imaging device 100 and an A/D conversion circuit 34 for converting color signals of RGB output from the analog signal processing section 33 into a digital signal. The analog signal processing section 33 and the A/D conversion circuit 34 are controlled by the CPU 25.

The electric control system of the digital camera further includes a memory control section 37 connected to main memory (frame memory) 36, a digital signal processing section 38 for performing interpolation computation, gamma correction computation, RGB/YC conversion processing, etc., a compression and decompression processing section 39 for compressing a picked-up image to a JPEG image and decompressing a compressed image, an integration section 40 for integrating photometric data to find a gain of white balance correction made by the digital signal processing section 38, an external memory control section 42 to which a detachable recording medium 41 is connected, and a display control section 44 to which a liquid crystal display section 43 installed in the camera rear, etc., is connected. These sections are connected to each other by a control bus 46 and a data bus 47 and are controlled according to a command from the CPU 25.

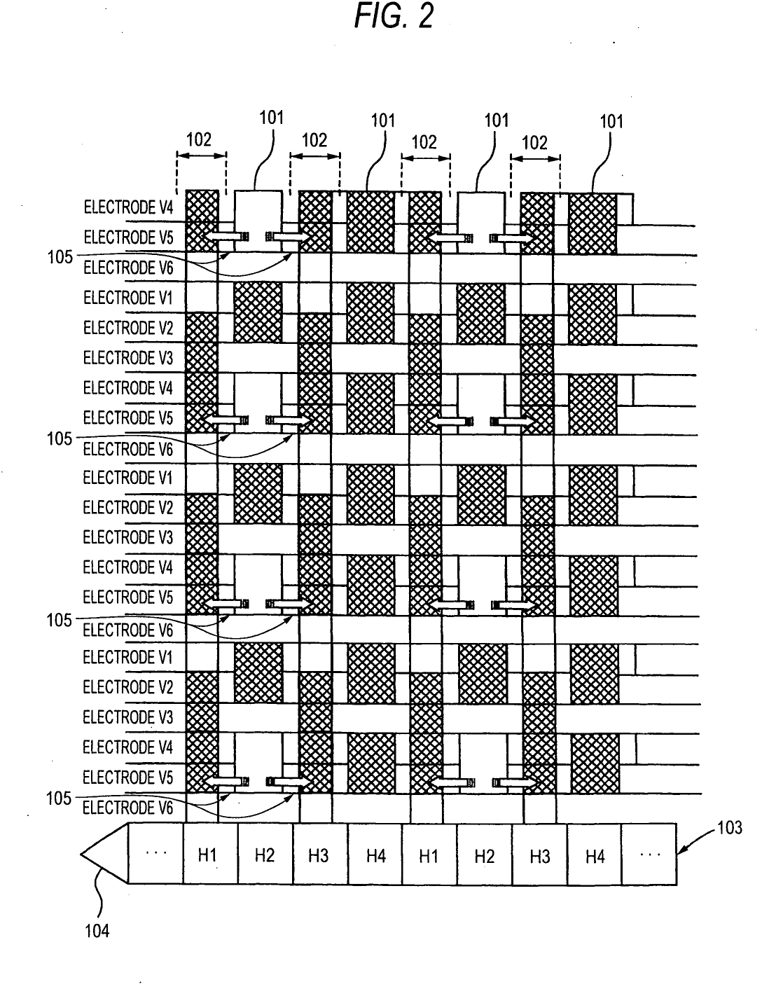

FIG. 2 is a plan view to show a solid-state imaging device 100 according to a first exemplary embodiment of the invention. As shown in FIG. 2, the solid-state imaging device 100 of the embodiment includes a semiconductor substrate and photoelectric conversion sections 101 disposed on the semiconductor substrate in a row direction (side to side direction in FIG. 2) and a column direction (up and down direction in FIG. 2) orthogonal to the row direction. The photoelectric conversion sections 101 are placed like a lattice with equal spacing relative to the row direction and the column direction. The photoelectric conversion sections 101 can use photodiodes, for example.

The solid-state imaging device 100 also includes VCCDs 102 for reading signal charges occurring in the photoelectric conversion sections 101 at the driving time and transferring the signal charges in the column direction and an HCCD 103 for transferring the signal charges from the VCCDs 102 in the row direction and outputting the signal charges to an output amplifier 104.

Each of the VCCDs 102 has a plurality of vertical charge transfer electrodes disposed in the column direction. The VCCD 102 of the embodiment has a repetitive pattern of six vertical charge transfer electrodes V1 to V6 disposed in the column direction. At the driving time, a drive pulse voltage is applied to the vertical charge transfer electrodes V1 to V6 at predetermined timings and the signal charges read from the photoelectric conversion sections 101 are transferred in the column direction.

The HCCD 103 has a plurality of horizontal charge transfer electrodes connected to end parts of the VCCDs 102 in the column direction and disposed in the row direction. In the embodiment, the HCCD 103 has a repetitive pattern of four horizontal charge transfer electrodes H1 to H4 disposed in the row direction. At the driving time, a drive pulse voltage is applied to the four horizontal charge transfer electrodes H1 to H4 at predetermined timings and the signal charges are transferred in the row direction.

The solid-state imaging device may have line memory including the electrodes at the end parts of the VCCDs 102 in the column direction arranged in a horizontal direction. The line memory has a function of temporarily accumulating the signal charges transferred from the VCCDs 102 and transferring the accumulated signal charges to the HCCD 103 at a predetermined timing; horizontal mixing in the HCCD 103 can be executed using the line memory. To adopt a configuration including no line memory as in the embodiment, a drive pulse voltage is applied to the horizontal charge transfer electrodes H1 to H4 making up the HCCD 103 at predetermined timings, whereby horizontal mixing in the HCCD 103 can be executed. In the embodiment, the four horizontal charge transfer electrodes H1 to H4 of the HCCD 103 are two-phase driven, whereby the horizontal mixing in the HCCD 103 is executed without using line memory.

Adding of the signal charges is not limited to the horizontal mixing in the HCCD 103. For example, at the driving time, after the signal charges are output from the HCCD 103, the analog signal processing section 33 (see FIG. 1) may execute addition processing of the signal charges read from the same the photoelectric conversion section.

The solid-state imaging device 100 of the embodiment has reading regions 105 for reading a signal charge generated in the photoelectric conversion section 101 into the vertical charge transfer electrodes on both sides adjacent to the photoelectric conversion section 101. The charge reading regions 105 are disposed so that they are adjacent to both sides of the photoelectric conversion section 101 in the row direction and the signal charge transfer directions are opposite to each other. The reading regions adjacent to the same photoelectric conversion section 101 are connected to the same vertical charge transfer electrode.

FIG. 2 shows one state example at the driving time of the solid-state imaging device 100, wherein the portion where a signal charge is accumulated is crosshatched and the portion where no signal charge is accumulated is not crosshatched and is shown as blank. In FIG. 2, when a read pulse is applied to the vertical charge transfer electrodes V5 of the VCCDs 102, signal charges are read from the remaining photoelectric conversion sections 101 resulting from thinning out every other photoelectric conversion section of the photoelectric conversion sections under the first and third columns from the left in the figure into the vertical charge transfer electrodes V2 to V5 adjacent to the photoelectric conversion sections 101. Here, the vertical charge transfer electrodes V1 and V6 in each VCCD 102 are caused to function as a barrier, whereby the signal charges are isolated from those of other photoelectric conversion sections 101.

In FIG. 2, in the photoelectric conversion sections 101 under the Nth column (where N is a natural number of 1 or more) from the left, the charge reading regions 105 are connected to the vertical charge transfer electrodes V2, VS and in the photoelectric conversion sections 101 under the N+1st column (where N is a natural number of 1 or more), the charge reading regions 105 are connected to the vertical charge transfer electrodes V1, V4. In so doing, simultaneous reading of the photoelectric conversion sections 101 under the even-numbered and odd-numbered columns is not executed, so that each photoelectric conversion section 101 can use the VCCDs 102 on both sides by reading signal charge into the VCCDs 102 alternately.

Next, the drive state of the solid-state imaging device 100 of the embodiment will be discussed based on the accompanying drawing.

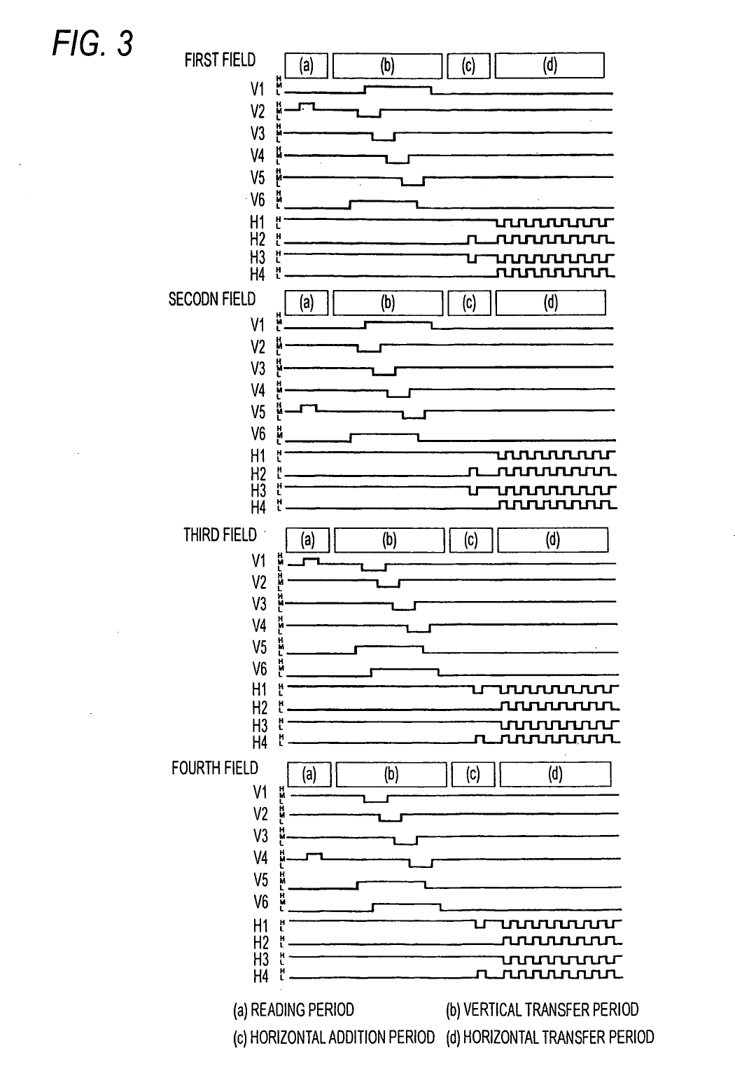

FIG. 3 is a timing chart of drive pulse voltage applied to the vertical charge transfer electrodes when the solid-state imaging device 100 shown in FIG. 2 is driven.

In the first field, in a reading period, a read pulse is applied to the vertical charge transfer electrode V2 and a signal charge is read from each of the even-numbered photoelectric conversion sections 101 from the top, of the photoelectric conversion sections 101 under the first and third columns from the left in FIG. 2 into the adjacent VCCDs 102 on both sides. Then, in a vertical transfer period, a drive pulse is applied to the vertical charge transfer electrodes and the barrier is moved gradually, whereby the signal charges are transferred to the HCCD 103 along the VCCDs 102.

In the second field, in a reading period, a read pulse is applied to the vertical charge transfer electrode VS and a signal charge is read from each of the odd-numbered photoelectric conversion sections 101 from the top, of the photoelectric conversion sections 101 under the first and third columns from the left in FIG. 2 into the adjacent VCCDs 102 on both sides. Then, in a vertical transfer period, a drive pulse is applied to the vertical charge transfer electrodes and the barrier is moved gradually, whereby the signal charges are transferred to the HCCD 103 along the VCCDs 102.

In the third field, in a reading period, a read pulse is applied to the vertical charge transfer electrode V1 and a signal charge is read from each of the odd-numbered (or even-numbered) photoelectric conversion sections 101 from the top, of the photoelectric conversion sections 101 under the second and fourth columns from the left in FIG. 2 into the adjacent VCCDs 102 on both sides. Then, in a vertical transfer period, a drive pulse is applied to the vertical charge transfer electrodes and the barrier is moved gradually, whereby the signal charges are transferred to the HCCD 103 along the VCCDs 102.

In the fourth field, in a reading period, a read pulse is applied to the vertical charge transfer electrode V4 and a signal charge is read from each of the even-numbered (or odd-numbered) photoelectric conversion sections 101 from the top, of the photoelectric conversion sections 101 under the second and fourth columns from the left in FIG. 2 into the adjacent VCCDs 102 on both sides. Then, in a vertical transfer period, a drive pulse is applied to the vertical charge transfer electrodes and the barrier is moved gradually, whereby the signal charges are transferred to the HCCD 103 along the VCCDs 102.

The operation is performed according to the procedure of the first field to the fourth field as described above, whereby the signal charges of all photoelectric conversion sections 101 can be read into the VCCDs 102 and can be transferred.

In the embodiment, the lower end part of the Nth VCCD 102 (where N is a natural number of 1 or more) is connected to the horizontal charge transfer electrode H1 of the HCCD 103 and the lower end part of the N+1st VCCD 102 (where N is a natural number of 1 or more) is connected to the horizontal charge transfer electrode H3 of the HCCD 103. Thus, the signal charges transferred in the VCCD 102 are accumulated in the horizontal charge transfer electrodes H1 and H3 and two-phase drive voltage is applied to the horizontal charge transfer electrodes H1 to H4 for performing horizontal mixing and then the signal charges are transferred in the horizontal direction (to the left in FIG. 2) and are output to the output section 104. To add the read signal charges, signal processing may be executed in the analog signal processing section 33.

At the driving time, the solid-state imaging device 100 of the embodiment can transfer the signal charge accumulated in the photoelectric conversion section 101 to the VCCDs 102 disposed adjacent to both sides of the photoelectric conversion section 101 at the same time. In the solid-state imaging device in the related art, the signal charge is read to the VCCD only on one side relative to the photoelectric conversion section and thus to make smaller the solid-state imaging device, it is necessary to increase the number of vertical charge transfer electrodes making up VCCD with an increase in the number of photoelectric conversion sections to be thinned out. In contrast, in the solid-state imaging device of the invention, the signal charge is read to the VCCDs 102 on both sides of the photoelectric conversion section 101, whereby the signal charge can be accumulated in the vertical charge transfer electrodes V2 to V5 making up each of the VCCDs 102. Thus, the signal charges of a larger capacity as compared with the solid-state imaging device in the related art are accumulated and the signal charges can be transferred at the same time in the vertical direction in the VCCDs 102. Since the signal charges of the same photoelectric conversion section 101 can be added by the VCCD 103 and the analog signal processing section 33, the capacity of the signal charges can be ensured without increasing the number of the vertical charge transfer electrodes V1 to V6 in response to making smaller the solid-state imaging device 100.

Next, a second exemplary embodiment of solid-state imaging device 100 according to the invention will be discussed.

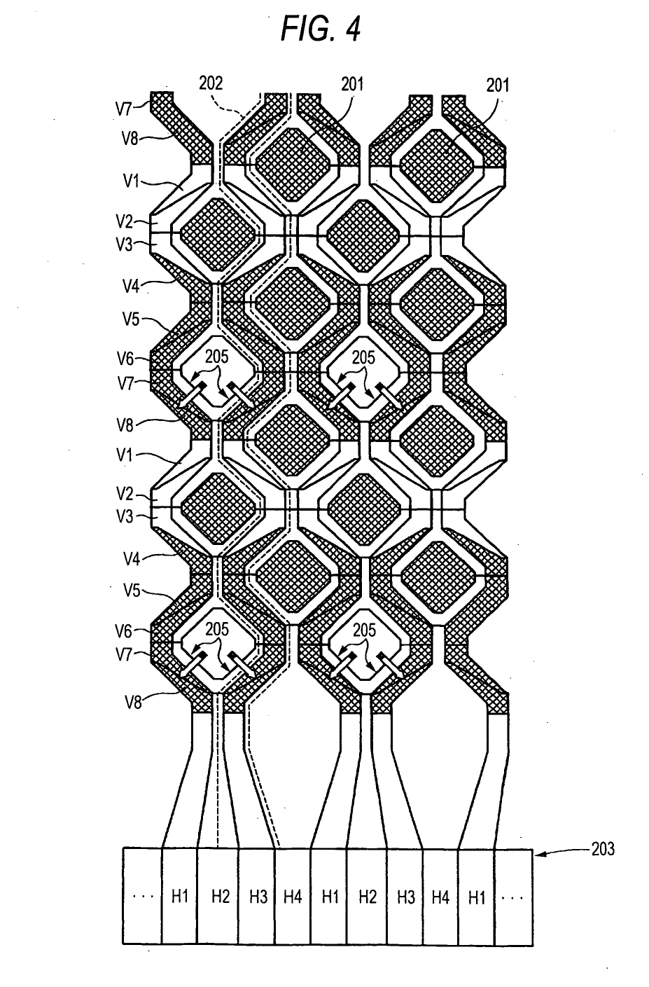

FIG. 4 is a plan view of a solid-state imaging device 100 of the embodiment of the invention. The basic configuration of the solid-state imaging device 100 is the same as that of the first embodiment described above. That is, the solid-state imaging device 100 includes a plurality of photoelectric conversion elements 201 arranged in a vertical direction and a horizontal direction orthogonal to the vertical direction on a semiconductor substrate, a plurality of VCCDs 202 for transferring charges occurring in the photoelectric conversion elements 201 in the vertical direction, and an HCCD 203 for transferring the charges transferred through the VCCDs 202 in the horizontal direction. In the embodiment, the vertical direction of the semiconductor substrate is the column direction and the horizontal direction is the row direction.

A large number of photoelectric conversion sections 201 are placed as an array of m photoelectric conversion element rows (where m is a natural number of two or more) in the vertical direction each consisting of n photoelectric conversion elements 201 (where n is a natural number of two or more) arranged in the horizontal direction or are placed as an array of n photoelectric conversion element rows in the horizontal direction each consisting of m photoelectric conversion elements 201 arranged in the vertical direction. The array is honeycomb arrangement wherein the odd-numbered photoelectric conversion element row is shifted by roughly a half of the photoelectric conversion element arrangement pitch of each photoelectric conversion element row relative to the even-numbered photoelectric conversion element row.

Each of the VCCDs 202 has a plurality of vertical charge transfer electrodes disposed in the column direction. The VCCD 202 of the embodiment has a repetitive pattern of eight vertical charge transfer electrodes V1 to V8 disposed in the column direction. At the driving time, a drive pulse voltage is applied to the vertical charge transfer electrodes V1 to V8 at predetermined timings and the signal charges read from the photoelectric conversion sections 201 are transferred in the row direction.

The HCCD 203 has a plurality of horizontal charge transfer electrodes connected to end parts of the VCCDs 202 in the column direction and disposed in the row direction. In the embodiment, the HCCD 203 has a repetitive pattern of four horizontal charge transfer electrodes H1 to H4 disposed in the row direction. At the driving time, a drive pulse voltage is applied to the four horizontal charge transfer electrodes H1 to H4 at predetermined timings and the signal charges are transferred in the row direction.

The solid-state imaging device may have line memory having the electrodes at the end parts of the VCCDs 202 in the column direction arranged in a horizontal direction.

The solid-state imaging device 100 of the embodiment has reading regions 205 for reading a signal charge occurring in the photoelectric conversion section 201 into the vertical charge transfer electrodes on both sides adjacent to the photoelectric conversion section 201. The charge reading regions 205 are disposed so that they are adjacent to both sides of the photoelectric conversion section 201 in the row direction and the signal charges are transferred to opposite VCCD sides in the row direction. The reading regions adjacent to the same photoelectric conversion section 201 are connected to the same vertical charge transfer electrode.

FIG. 4 shows one state example at the driving time of the solid-state imaging device 100, wherein the portion where a signal charge is accumulated is crosshatched and the portion where no signal charge is accumulated is not crosshatched and is shown as blank. In FIG. 4, when a read pulse is applied to the vertical charge transfer electrodes V7 of the VCCDs 202, signal charges are read from the remaining photoelectric conversion sections 201 resulting from thinning out in the vertical direction every other photoelectric conversion section of the photoelectric conversion sections under the first and third columns from the left in the figure into the vertical charge transfer electrodes V4 to V8 adjacent to the photoelectric conversion sections 201. Here, the vertical charge transfer electrodes V1 to V3 in each VCCD 202 are caused to function as a barrier, whereby the signal charges arc isolated from those of other photoelectric conversion sections 201.

In FIG. 4, in the photoelectric conversion sections 201 under the Nth column (where N is a natural number of 1 or more) from the left, the charge reading regions 205 are connected to the vertical charge transfer electrodes V3, V7 and in the photoelectric conversion sections 201 under the N+1st column (where N is a natural number of 1 or more), the charge reading regions 205 are connected to the vertical charge transfer electrodes V1, V5. In so doing, simultaneous reading of the photoelectric conversion sections 201 under the even-numbered and odd-numbered columns is not executed, so that each photoelectric conversion section 201 can use the VCCDs 202 on both sides by reading signal charge into the VCCDs 202 alternately.

Next, the drive state of the solid-state imaging device 100 of the embodiment will be discussed based on the accompanying drawing.

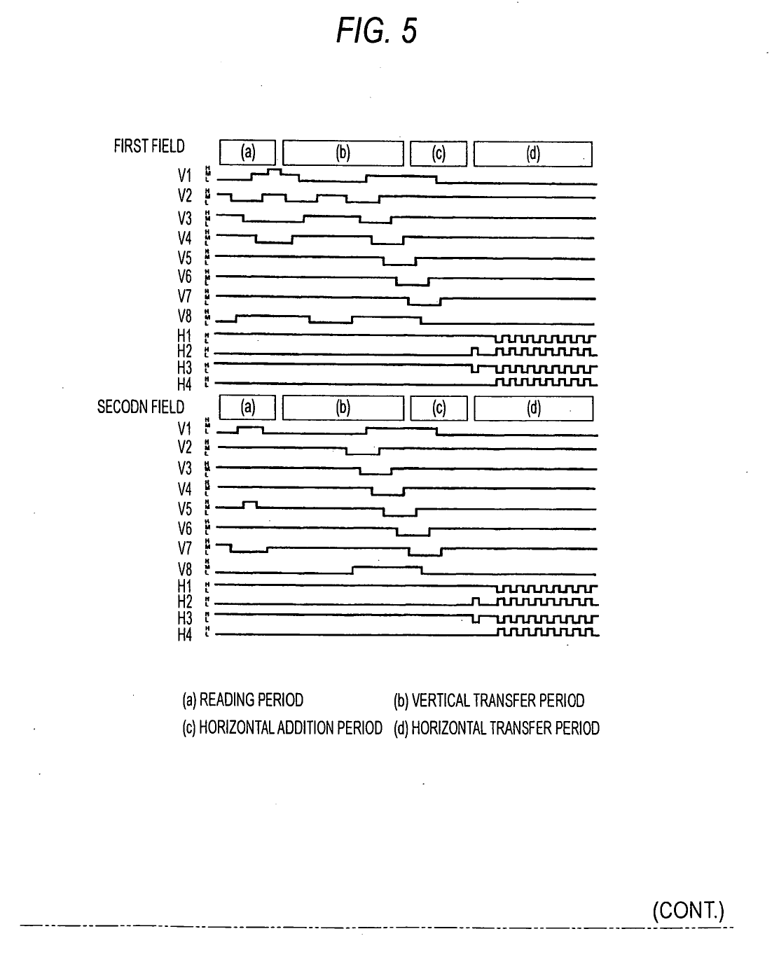

FIG. 5 is a timing chart of drive pulse voltage applied to the vertical charge transfer electrodes when the solid-state imaging device 100 shown in FIG. 4 is driven.

In the first field, in a reading period, a drive pulse voltage is applied to the vertical charge transfer electrodes V1 to V4 at the timing shown in FIG. 5, whereby a signal charge is read from each of the odd-numbered photoelectric conversion elements 201 from the top, of the photoelectric conversion sections 201 under the second and fourth columns from the left in FIG. 4 into the adjacent VCCDs 202 on both sides. Then, in a vertical transfer period, a drive pulse is applied to the vertical charge transfer electrodes and the barrier is moved gradually, whereby the signal charges are transferred to the horizontal charge transfer electrode H3 of the HCCD 203 along the VCCDs 202.

In the second field, in a reading period, a drive pulse voltage is applied to the vertical charge transfer electrodes V1, V5, and V7 at the timing shown in FIG. 5, whereby a signal charge is read from each of the even-numbered photoelectric conversion elements 201 from the top, of the photoelectric conversion sections 201 under the second and fourth columns from the left in FIG. 4 into the adjacent VCCDs 202 on both sides. Then, in a vertical transfer period, a drive pulse is applied to the vertical charge transfer electrodes and the barrier is moved gradually, whereby the signal charges are transferred to the horizontal charge transfer electrode H3 of the HCCD 203 along the VCCDs 202.

In the third field, in a reading period, a drive pulse voltage is applied to the vertical charge transfer electrodes V1, V3, V5, V6, V7, and V8 at the timing shown in FIG. 5, whereby a signal charge is read from each of the odd-numbered photoelectric conversion elements 201 from the top, of the photoelectric conversion sections 201 under the first and third columns from the left in FIG. 4 into the adjacent VCCDs 202 on both sides. Then, in a vertical transfer period, a drive pulse is applied to the vertical charge transfer electrodes and the barrier is moved gradually, whereby the signal charges are transferred to the horizontal charge transfer electrode H1 of the HCCD 203 along the VCCDs 202.

In the fourth field, in a reading period, a drive pulse voltage is applied to the vertical charge transfer electrodes V2, V7, and V8 at the timing shown in FIG. 5, whereby a signal charge is read from each of the even-numbered photoelectric conversion elements 201 from the top, of the photoelectric conversion sections 201 under the first and third columns from the left in FIG. 4 into the adjacent VCCDs 202 on both sides. Then, in a vertical transfer period, a drive pulse is applied to the vertical charge transfer electrodes and the barrier is moved gradually, whereby the signal charges are transferred to the horizontal charge transfer electrode H1 of the HCCD 203 along the VCCDs 202.

The operation is performed according to the procedure of the first field to the fourth field as described above, whereby the signal charges of all photoelectric conversion sections 201 can be read into the VCCDs 202 and can be transferred.

In the embodiment, the lower end part of the Nth VCCD 202 (where N is a natural number of 1 or more) is connected to the horizontal charge transfer electrode H1 of the HCCD 203 and the lower end part of the N+1st VCCD 202 (where N is a natural number of 1 or more) is connected to the horizontal charge transfer electrode H3 of the HCCD 203. Thus, the signal charges transferred in the VCCD 202 are accumulated in the horizontal charge transfer electrodes H1 and H3 and two-phase drive voltage is applied to the horizontal charge transfer electrodes H1 to H4 for performing horizontal mixing and then the signal charges are transferred in the horizontal direction (to the left in FIG. 4) and are output to an output section 104. To add the read signal charges, signal processing may be executed in an analog signal processing section 33.

At the driving time, like the solid-state imaging device 100 of the first embodiment described above, the solid-state imaging device 100 of the second embodiment can transfer the signal charge accumulated in the photoelectric conversion section 201 to the VCCDs 202 disposed adjacent to both sides of the photoelectric conversion section 201 at the same time. Thus, the signal charge is read to the VCCDs 202 on both sides of the photoelectric conversion section 201, whereby the signal charge can be accumulated in the vertical charge transfer electrodes V4 to V8 making up each of the VCCDs 202. Thus, the signal charges of a larger capacity as compared with the solid-state imaging device in the related art are accumulated and the signal charges can be transferred at the same time in the vertical direction in the VCCDs 202. Since the signal charges of the same photoelectric conversion section 201 can be added by the HCCD 203 and the analog signal processing section 33, the capacity of the signal charges can be ensured without increasing the number of the vertical charge transfer electrodes V1 to V8 in response to making smaller the solid-state imaging device 100.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2007-007986, filed Jan. 17, 2007, the entire disclosure of which is herein incorporated by reference.

What is claimed is:

1. A solid-state imaging device comprising:
a semiconductor substrate;
a plurality of photoelectric conversion sections disposed in a row direction and a column direction orthogonal to the row direction in the semiconductor substrate;
vertical charge transfer sections that transfers signal charges generated in the photoelectric conversion sections in the column direction, wherein the vertical charge transfer sections includes: a plurality of vertical charge transfer electrodes disposed in the column direction and between columns of the photoelectric conversion sections; and charge reading regions that read the signal charges generated in each of the photoelectric conversion section into the vertical charge transfer electrodes on both sides adjacent to the each of the photoelectric conversion section; and
a horizontal charge transfer section that transfers the signal charges from the vertical charge transfer sections in the row direction

2. The solid-state imaging device according to claim 1, wherein the horizontal charge transfer section includes four or more horizontal charge transfer electrodes arranged in order in the row direction.

3. The solid-state imaging device according to claim 1, further comprising a line memory that temporarily accumulates the signal charges transferred from the vertical charge transfer sections.

4. A method for driving a solid-state imaging device including: a semiconductor substrate; a plurality of photoelectric conversion sections disposed in a row direction and a column direction orthogonal to the row direction in the semiconductor substrate; vertical charge transfer sections that transfers signal charges generated in the photoelectric conversion sections in the column direction, the vertical charge transfer sections including a plurality of vertical charge transfer electrodes disposed in the column direction and between columns of the photoelectric conversion sections; and a horizontal charge transfer section that transfers the signal charges from the vertical charge transfer sections in the row direction, the method comprising reading the signal charges generated in each of the photoelectric conversion section into the vertical charge transfer electrodes on both sides adjacent to the each of the photoelectric conversion section.

5. The method according to claim 4, further comprising adding the signal charges read from the same photoelectric conversion section in the horizontal charge transfer section.

6. The method according to claim 4, further comprising: outputting the signal charges from the horizontal charge transfer section; and adding the signal charges read from the same photoelectric conversion section in a signal processing section.

7. An imaging apparatus comprising a solid-state imaging device that performs photoelectric conversion of light from a subject,
the solid-state imaging device including:
a semiconductor substrate;
a plurality of photoelectric conversion sections disposed in a row direction and a column direction orthogonal to the row direction in the semiconductor substrate;
vertical charge transfer sections that transfers signal charges generated in the photoelectric conversion sections in the column direction, wherein the vertical charge transfer sections includes: a plurality of vertical charge transfer electrodes disposed in the column direction and between columns of the photoelectric conversion sections; and charge reading regions that read the signal charges generated in each of the photoelectric conversion section into the vertical charge transfer electrodes on both sides adjacent to the each of the photoelectric conversion section; and
a horizontal charge transfer section that transfers the signal charges from the vertical charge transfer sections in the row direction.
